(19) United States
(12) Patent Application Publication
(10) Pub. No.: US 2010/0013195 A1
(43) Pub. Date: Jan. 21, 2010

(54) Foldable Stroller

(76) Inventor: Chuan-Kai Hsu, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/175,662

(22) Filed: Jul. 18, 2008

(51) Int. Cl. B62B 3/02

(52) U.S. Cl. 280/642

(57) ABSTRACT

A foldable stroller includes a support frame including two back posts, a first folding bar, a second folding bar, a third folding bar, a fourth folding bar, a bottom bracket, and a slide. The two back posts are rotated backward and downward toward the first folding bar to fold the third folding bar and the second folding bar between the two back posts and the first folding bar and to fold the bottom bracket under the first folding bar so as to fold the stroller. Thus, when the stroller is folded, the back posts are rotated backward and downward to reduce the volume of the support frame to the minimum value so that the folded stroller has the smallest volume, thereby facilitating storage and transportation of the stroller when not in use.

### BACKGROUND OF THE INVENTION

1. Field of the Invention

The present invention relates to a stroller and, more particularly, to a foldable stroller.

2. Description of the Related Art

A conventional foldable stroller comprises a support frame, a seat mounted in the support frame, a shading canopy mounted on the support frame to shade the seat, and a plurality of rollers mounted on a lower portion of the support frame. However, the support frame consists of multiple connecting links, so that the support frame is not folded and expanded easily and quickly, thereby causing inconvenience to a user when folding and expanding the stroller. In addition, the support frame has a larger volume when being folded so that the folded stroller has a larger volume to occupy a larger space, thereby causing inconvenience in storage and transportation of the stroller when not in use.

### BRIEF SUMMARY OF THE INVENTION

In accordance with the present invention, there is provided a foldable stroller, comprising a support frame including two hollow back posts, a first folding bar, a second folding bar, a third folding bar, a fourth folding bar, a bottom bracket, and a slide. Each of the two back posts has a lower end pivotally connected with the first folding bar. The slide is movable on the bottom bracket. The second folding bar is pivotally connected between the slide and the third folding bar. The third folding bar is pivotally connected between the two back posts and the second folding bar. The fourth folding bar is pivotally connected between the two back posts and the bottom bracket.

The primary objective of the present invention is to provide a foldable stroller having a smaller volume when being folded.

Another objective of the present invention is to provide a foldable stroller, wherein when the stroller is folded, the two back posts are rotated backward and downward to reduce the volume of the support frame to the minimum value so that the folded stroller has the smallest volume, thereby facilitating storage and transportation of the stroller when not in use.

A further objective of the present invention is to provide a foldable stroller that is folded easily and quickly, thereby facilitating a user folding and expanding the stroller.

A further objective of the present invention is to provide a foldable stroller, wherein the two back posts are rotated backward and downward toward the first folding bar to fold the third folding bar and the second folding bar between the two back posts and the first folding bar and to fold the bottom bracket and the rollers under the first folding bar so as to fold the stroller to have the minimum volume.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a foldable stroller in accordance with the preferred embodiment of the present invention.

FIG. 2 is a side perspective view of the foldable stroller as shown in FIG. 1.

FIG. 3 is a rear perspective view of the foldable stroller as shown in FIG. 1.

FIGS. 4-6 are schematic side operational view of the foldable stroller as shown in FIG. 1.

### DETAILED DESCRIPTION OF THE INVENTION

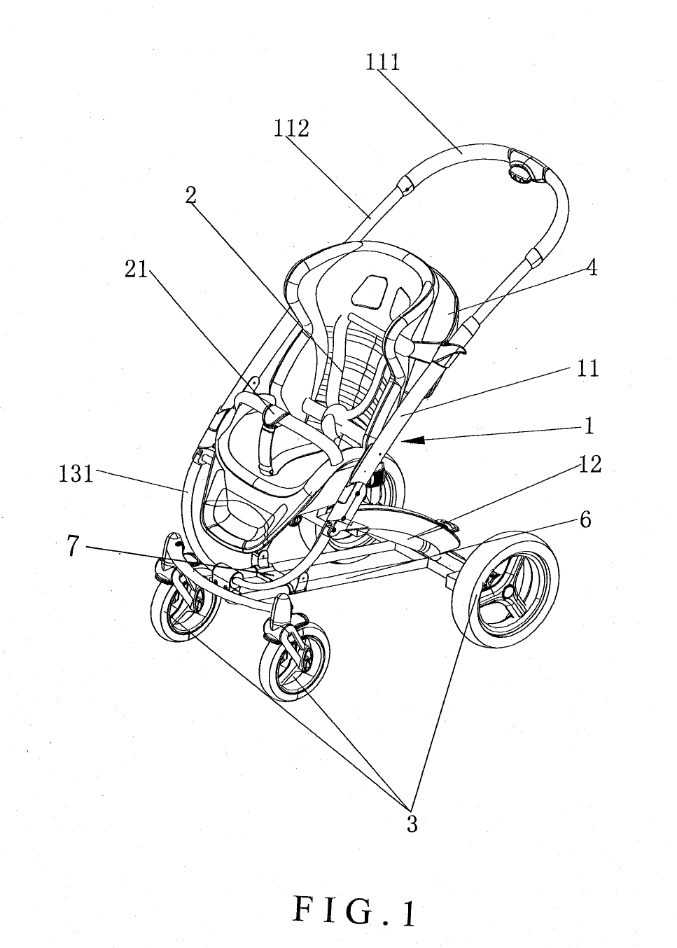

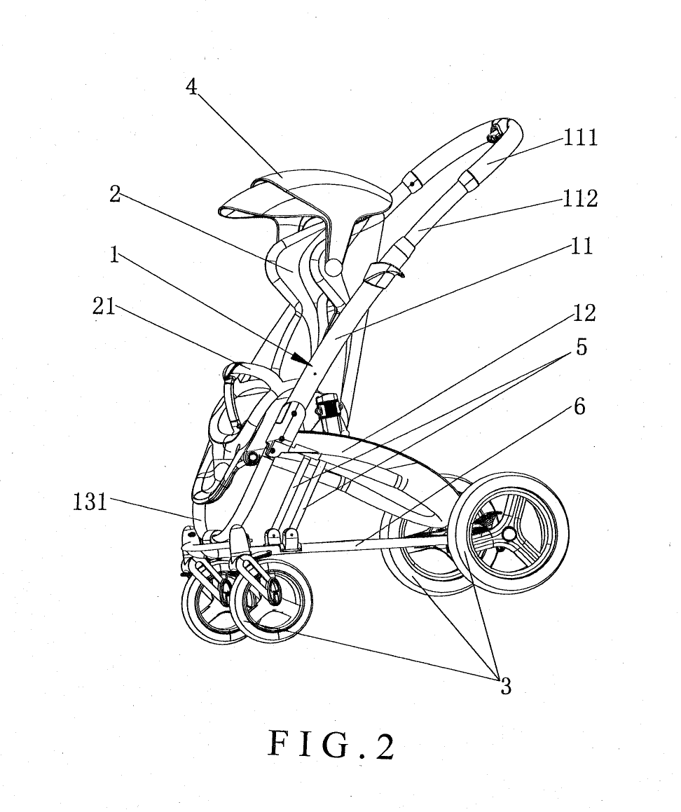

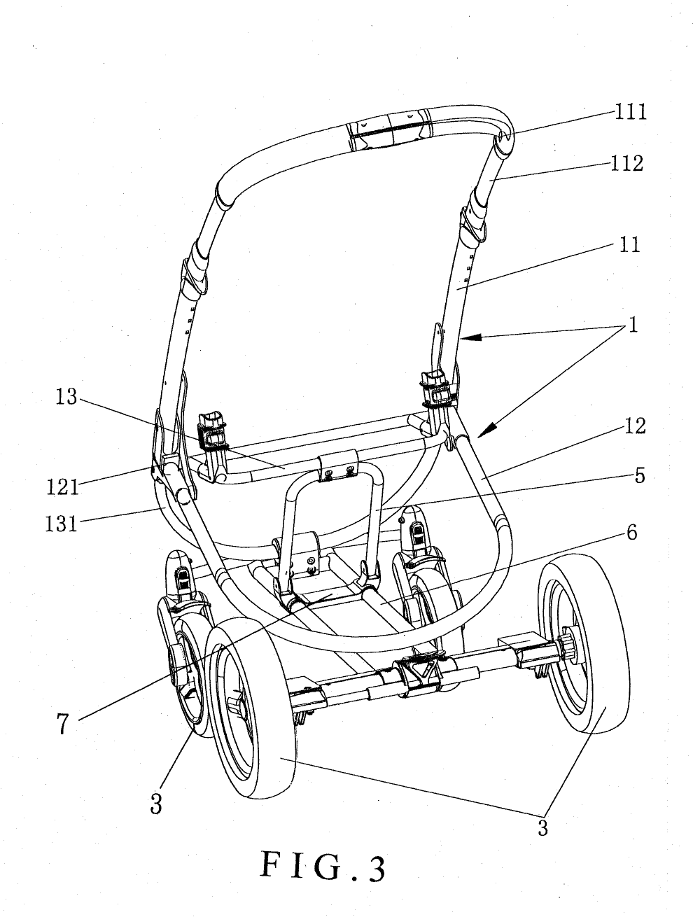

Referring to the drawings and initially to FIGS. 1-3, a foldable stroller in accordance with the preferred embodiment of the present invention comprises a support frame 1, a seat 2 mounted in the support frame 1, a shading canopy 4 mounted on an upper end of the seat 2, an armrest 21 mounted on a front side of the seat 2 to provide a baby placed in the seat 2, and a plurality of rollers 3 mounted on a lower portion of the support frame 1.

The support frame 1 includes two hollow back posts 11, two retractable bars 112, a handlebar 111, a first folding bar 12, a positioning articulation 121, a second folding bar 5, a third folding bar 13, a fourth folding bar 131, a bottom bracket 6, and a slide 7.

Each of the two back posts 11 is a tube. Each of the two back posts 11 has an upper end connected with a respective one of the two retractable bars 112 and a lower end pivotally connected with the first folding bar 12.

Each of the two retractable bars 112 has an upper end connected with an end of the handlebar 111 and a lower end retractably mounted in a respective one of the two back posts 11.

The first folding bar 12 is located under the two back posts 11. The first folding bar 12 has two opposite ends each pivotally connected with a respective one of the two back posts 11.

The slide 7 is movable on the bottom bracket 6.

The second folding bar 5 is pivotally connected between the slide 7 and the third folding bar 13.

The third folding bar 13 is pivotally connected between the two back posts 11 and the second folding bar 5. The third folding bar 13 is also pivotally connected with the first folding bar 12. The third folding bar 13 has an end pivotally connected with an end of the fourth folding bar 131.

The fourth folding bar 131 is pivotally connected between the two back posts 11 and the bottom bracket 6.

The bottom bracket 6 is pivotally connected with the second folding bar 5 by the slide 7 and has an end pivotally connected with an end of the fourth folding bar 131. The bottom bracket 6 is used to support the rollers 3.

The positioning articulation 121 is used to connect the two back posts 11, the first folding bar 12, the third folding bar 13 and the fourth folding bar 131.

The two back posts 11, the first folding bar 12, the second folding bar 5 and the third folding bar 13 construct a first linkage. The first folding bar 12, the fourth folding bar 131 and the bottom bracket 6 construct a second linkage.

The first folding bar 12 has a substantially U-shaped profile, the second folding bar 5 has a substantially U-shaped profile, and the third folding bar 13 has a substantially U-shaped profile.

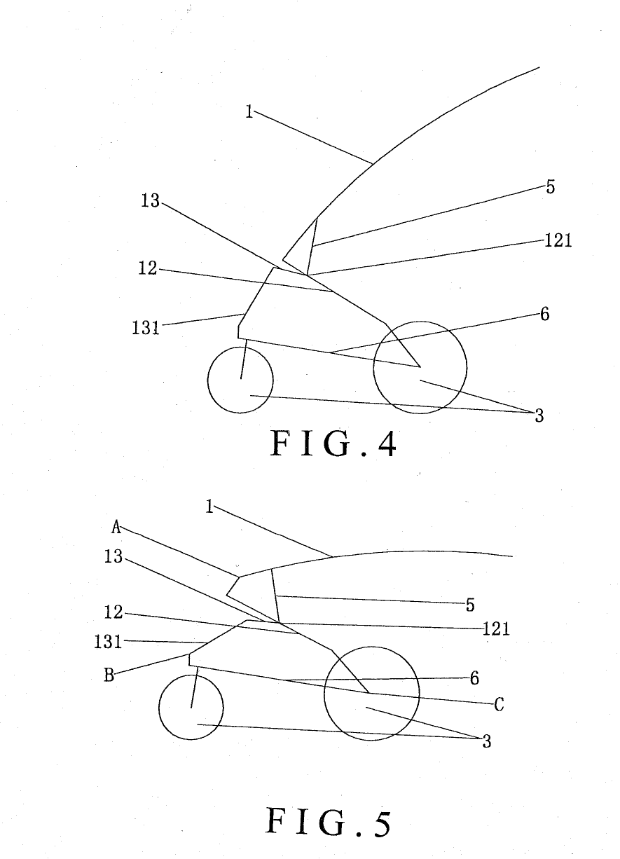

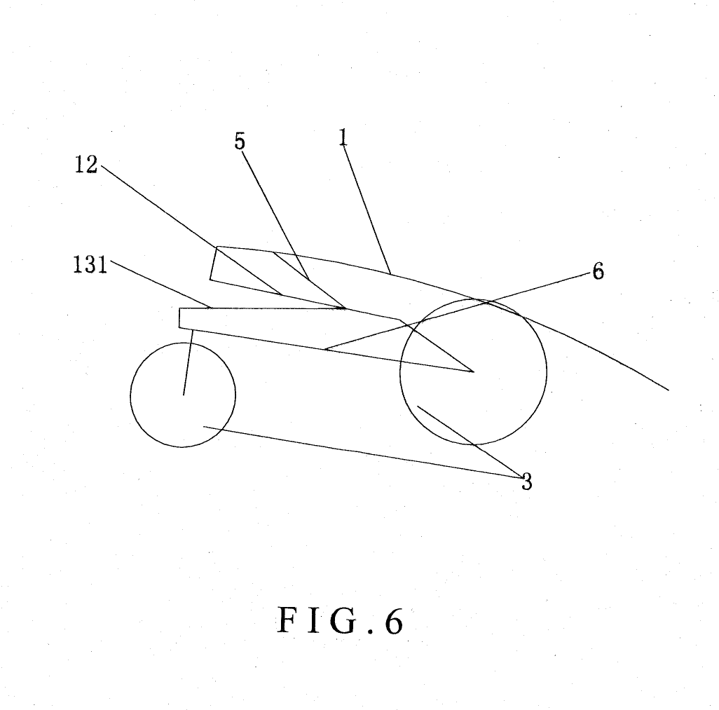

In operation, referring to FIGS. 4-6 with reference to FIGS. 1-3, when a user wishes to fold the stroller or when the stroller is not in use, the locked state of the stroller is released. Then, the handlebar 111 is pushed downward to retract the two retractable bars 112 into the two back posts 11. Then, the two back posts 11 are rotated backward and downward toward the first folding bar 12 to drive and move the third folding bar 13 backward and downward to push the second folding bar 5 which pushes the slide 7 to slide backward on the bottom bracket 6 so as to fold the third folding bar 13 and the second folding bar 5 between the two back posts 11 and the first folding bar 12. At the same time, when the two back posts 11 are rotated backward and downward toward the first folding bar 12, the fourth folding bar 131 is driven by the two back posts 11 to rotate forward and upward and to drive the bottom bracket 6 to move forward so as to fold the rollers 3. Thus, the two back posts 11 are rotated backward and downward toward the first folding bar 12 to fold the third folding bar 13 and the second folding bar 5 between the two back posts 11 and the first folding bar 12 and to fold the bottom bracket 6 and the rollers 3 under the first folding bar 12 so as to fold the stroller.

On the contrary, the handlebar 111 is pulled outwardly to pull the two retractable bars 112 outwardly from the two back posts 11. Then, the two back posts 11 are rotated upward and forward to drive and move the third folding bar 13 forward and upward to pull the second folding bar 5 which pulls the slide 7 to slide forward on the bottom bracket 6 so as to expand the third folding bar 13 and the second folding bar 5 between the two back posts 11 and the first folding bar 12 as shown in FIG. 1. At the same time, when the two back posts 11 are rotated upward and forward, the fourth folding bar 131 is driven by the two back posts 11 to rotate backward and downward and to drive the bottom bracket 6 to move backward so as to expand the rollers 3. Thus, the two back posts 11 are rotated upward and forward relative to the first folding bar 12 to expand the third folding bar 13 and the second folding bar 5 between the two back posts 11 and the first folding bar 12 and to expand the bottom bracket 6 and the rollers 3 so as to expand the stroller.

Accordingly, when the stroller is folded, the two back posts 11 are rotated backward and downward to reduce the volume of the support frame 1 to the minimum value so that the folded stroller has the smallest volume, thereby facilitating storage and transportation of the stroller when not in use. In addition, the stroller is folded easily and quickly, thereby facilitating a user folding and expanding the stroller. Further, the two back posts 11 are rotated backward and downward toward the first folding bar 12 to fold the third folding bar 13 and the second folding bar 5 between the two back posts 11 and the first folding bar 12 and to fold the bottom bracket 6 and the rollers 3 under the first folding bar 12 so as to fold the stroller to have the minimum volume.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A foldable stroller, comprising:
a support frame including two hollow back posts, a first folding bar, a second folding bar, a third folding bar, a fourth folding bar, a bottom bracket, and a slide; wherein:
each of the two back posts has a lower end pivotally connected with the first folding bar;
the slide is movable on the bottom bracket;
the second folding bar is pivotally connected between the slide and the third folding bar;
the third folding bar is pivotally connected between the two back posts and the second folding bar;
the fourth folding bar is pivotally connected between the two back posts and the bottom bracket.

2. The foldable stroller in accordance with claim 1, wherein the third folding bar is pivotally connected with the first folding bar.

3. The foldable stroller in accordance with claim 1, wherein the third folding bar has an end pivotally connected with an end of the fourth folding bar.

4. The foldable stroller in accordance with claim 1, wherein the support frame further includes:
a positioning articulation for connecting the two back posts, the first folding bar, the third folding bar and the fourth folding bar.

5. The foldable stroller in accordance with claim 1, wherein
the two back posts, the first folding bar, the second folding bar and the third folding bar construct a first linkage;
the first folding bar, the fourth folding bar and the bottom bracket construct a second linkage.

6. The foldable stroller in accordance with claim 1, wherein the first folding bar has a substantially U-shaped profile.

7. The foldable stroller in accordance with claim 1, wherein the second folding bar has a substantially U-shaped profile.

8. The foldable stroller in accordance with claim 1, wherein the third folding bar has a substantially U-shaped profile.

9. The foldable stroller in accordance with claim 1, wherein the bottom bracket is pivotally connected with the second folding bar by the slide.

10. The foldable stroller in accordance with claim 1, wherein the bottom bracket has an end pivotally connected with an end of the fourth folding bar.

11. The foldable stroller in accordance with claim 1, wherein the bottom bracket supports a plurality of rollers.

12. The foldable stroller in accordance with claim 1, wherein the first folding bar has two opposite ends each pivotally connected with a respective one of the two back posts.

13. The foldable stroller in accordance with claim 1, wherein the first folding bar is located under the two back posts.

14. The foldable stroller in accordance with claim 1, wherein the two back posts are rotated backward and downward toward the first folding bar to drive and move the third folding bar backward and downward to push the second folding bar which pushes the slide to slide backward on the bottom bracket so as to fold the third folding bar and the second folding bar between the two back posts and the first folding bar.

15. The foldable stroller in accordance with claim 14, wherein when the two back posts are rotated backward and downward toward the first folding bar, the fourth folding bar is driven by the two back posts to rotate forward and upward and to drive the bottom bracket to move forward so as to fold the rollers.

16. The foldable stroller in accordance with claim 1, wherein each of the two back posts is a tube.

17. The foldable stroller in accordance with claim 1, wherein
the support frame further includes two retractable bars and a handlebar;
each of the two back posts has an upper end connected with a respective one of the two retractable bars;
each of the two retractable bars has an upper end connected with an end of the handlebar and a lower end retractably mounted in a respective one of the two back posts.
